(19) United States
(12) Patent Application Publication
(10) Pub. No.: US 2011/0074817 A1
(43) Pub. Date: Mar. 31, 2011

(54) COMPOSITE PICTURE FORMING METHOD AND PICTURE FORMING APPARATUS

(76) Inventors: Shinichi Shinoda, Hitachi (JP); Yasutaka Toyoda, Mito (JP); Ryoichi Matsuoka, Yotsukaido (JP); Atsushi Miyamoto, Yokohama (JP); Go Kotaki, Kumamoto (JP)

(21) Appl. No.: 12/871,675

(22) Filed: Aug. 30, 2010

(30) Foreign Application Priority Data
Sep. 30, 2009 (JP) 2009-225933

(51) Int. Cl. G09G 5/00

(52) U.S. Cl. 345/634

(57) ABSTRACT

A composite picture forming method and picture forming apparatus forms pattern attribute information contained in an overlapping domain for the overlapping domain between a plurality of pictures to select the pictures to be targeted for a composition in accordance with the pattern attribute information and combine the selected pictures, and the composition of the pictures is also performed in plural stages by using the pattern attribute information in the overlapping domain.

### BACKGROUND OF THE INVENTION

The present invention relates to a method and an apparatus for combining a plurality of pictures to form a composite picture, and in particularly to a composite picture forming method and a picture forming apparatus for realizing a coupling between the plurality of pictures in high accuracy.

Recently, fine semiconductor devices have advanced for improving the performance of semiconductor device and reducing its manufacturing cost. For a purpose of evaluating a fine pattern finish for the semiconductor device, a semiconductor measurement and inspection device mounting with a critical-dimension scanning electron microscope (CD-SEM) etc, has been used. These devices image a picture of pattern in a high magnification ratio as high as several tens of thousands to hundreds of thousands times to process the acquired picture so that they evaluate a fine pattern shape in high accuracy.

However, according to the restriction of the SEM configuration, when a pattern domain to be evaluated is extended to a wide range since an imaging magnification ratio of the SEM is set in high to make a visual field size small, a method is effective that the pattern domain is divided into plural numbers thereof to then image a picture and thereafter combine the pictures (to make it panoramic), as disclosed in JP-A-61-22549 and JP-A-07-130319. However, since the pattern of electronic devices is mostly monotone straight line, a matching point appears plural numbers when determining a composite position between pictures, therefore, the composite position cannot sometimes be specified.

JP-A-2009-157543 has disclosed a technique such that pattern designed data is analyzed at a previous step of imaging a pattern and the pattern is imaged so as to enter the pattern, which easily specifies the composite position of the picture, into an overlapping domain between the pictures to be targeted for a composition to thereby enhance a matching easiness and perform a panoramic composition of semiconductor circuit patterns. There has also been a method such that a picture position is optimized to perform the panoramic composition while fitting together between proximity pictures as disclosed in JP-A-2001-512252.

### SUMMARY OF THE INVENTION

However, in even the case disclosed in JP-A-2009-157543, the composition cannot sometimes be realized depending on the pattern shape since the pattern shape of designed data is different from an actually manufactured pattern shape. Further, as disclosed in JP-A-2001-512252, even when the picture position is optimized while fitting together between proximity pictures, the picture position cannot be specified since the monotone straight line pattern can be fitted in any straight line directions. Furthermore, even though the picture position is specified while fitting together between the entire pictures, it is necessary to repeat the composition in a number of times. This is impractical since it takes a lot of time for processing a number of compositions.

An object of the invention is to provide a composite picture forming method and a picture forming apparatus capable of appropriately forming a composite picture in response to a pattern condition of the overlapping domain.

In order to realize the above-mentioned object, according to an aspect of the invention, a composite picture forming method and a picture forming apparatus for combining a plurality of pictures to form a composite picture, is proposed that pattern attribute information contained in an overlapping domain between a plurality of pictures is formed, the picture to be targeted for a composition is selected on the basis of the pattern attribute information, and a picture composition is performed on the basis of the selected picture.

According to another aspect of the invention, the composite picture forming method and the picture forming apparatus is proposed that the picture composition is performed in plural stages by using the pattern attribute information in the overlapping domain.

According to still another aspect of the invention, the composite picture forming method and the picture forming apparatus is proposed that the composition is selectively performed for between the pictures when the pattern attribute information contained in the overlapping domain between the pictures satisfies a predetermined condition, either a plurality of composite pictures or one composite picture is formed, and the composition is performed for between either the plurality of composite pictures or between the composite picture and the picture which is not combined.

According to the above-mentioned configuration, the pattern composition can be performed appropriately since the overlapping domain is evaluated for propriety of the composition to then perform the picture composition.

The other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram showing an example of a composite picture forming apparatus;

FIG. 2 is an explanatory diagram showing another example of the composite picture forming apparatus;

FIG. 3 is an explanatory diagram showing still another example of the composite picture forming apparatus;

FIGS. 4A to 4F are explanatory diagrams showing an outline of a picture composition;

FIG. 5 is an explanatory diagram showing an example of a pattern attribute data forming unit in the composite picture forming apparatus;

FIGS. 6A to 6L are diagrams showing autocorrelation pictures of pattern line segment picture;

FIG. 7 is an explanatory diagram showing an example of a composite selection unit in the composite picture forming apparatus;

FIG. 8 is an explanatory diagram showing an example of a composite unit in the composite picture forming apparatus;

FIG. 9 is an explanatory diagram showing an example of a group-in composite position calculation unit provided in the composite unit of the composite picture forming apparatus;

FIGS. 10A to 10D are explanatory diagrams showing an outline of grouping the pictures;

FIGS. 11A to 11C are explanatory diagrams showing an outline of grouping the pictures;

FIGS. 12A and 12B are explanatory diagrams showing an example of a pattern attribute data table;

FIG. 13 is an explanatory diagram showing another example of the pattern attribute data forming unit in the composite picture forming apparatus;

FIG. 14 is an explanatory diagram showing another example of the composite unit in the composite pictures forming apparatus;

FIG. 15 is an explanatory diagram showing another example of the composite selection unit in the composite picture forming unit;

FIGS. 16A to 16D are explanatory diagrams for explaining a technique to specify a relative position between picture groups by using the pattern attribute data;

FIG. 17 is an explanatory diagram showing an example of a position specified composition unit in the composite picture forming apparatus;

FIG. 18 is an explanatory diagram showing an example of a position correcting unit provided in the position specified composite unit of the composite picture forming apparatus;

FIG. 19 is a flowchart for explaining steps of a picture composite process;

FIG. 20 is an explanatory diagram of a measurement system connected with a plurality of SEMs; and

FIG. 21 is a schematic configuration diagram showing an electron scanning microscope.

### DETAILED DESCRIPTION OF THE INVENTION

Hereinafter, in a composite picture forming method for a picture having an electronic device pattern acquired from an imaging device of such as SEM, the method will be described with use of design data and picture data for the overlapping domain of the picture data to be targeted and use of a step of forming attribute information of a pattern contained in the respective overlapping domains and the attribute information of the formed pattern, to then select a picture to be combined from the targeted picture data to perform a picture composition.

In the composite picture forming method for a picture having the electronic device pattern acquired from the imaging device, a method will be described with use of the design data and the picture data for all of the overlapping domains of the picture data to be targeted and use of the step of forming the attribute information of the pattern contained in the respective overlapping domains and the attribute information of the formed pattern, to perform a step of selecting the picture to be combined from the picture data to be targeted to thereby perform a picture composition and a step of detecting and selecting a combination of the specified pattern attribute information to perform the picture composition for a plurality of overlapping domains of the targeted composite picture.

In a composite picture forming apparatus for a picture having the electronic device pattern acquired from the imaging device, the composite picture forming apparatus will be described with use of a picture storing unit that stores plural pieces of divided picture data acquired from imaging the electronic device pattern of which an imaged position is varied, a pattern attribute forming unit that forms pattern information contained between the pictures by using the design data of the electronic device pattern and the picture data stored in the image storing unit, a composite selection unit that selects the pictures to be combined in accordance with the information from the pattern attribute forming unit, and a composite unit that selectively performs a composite process for the selected picture by the composite selecting unit.

In the composite picture forming apparatus for the picture having the electronic device pattern acquired from the imaging device, the composite picture forming apparatus will be described with use of a picture storing unit that stores plural pieces of divided picture data acquired from imaging the electronic device pattern of which an imaged position is varied, a pattern attribute forming unit that forms the pattern information contained between the pictures by using the design data of the electronic device pattern and the picture data stored in the image storing unit, a composite selection unit that selects the picture to be combined in accordance with the information from the pattern attribute forming unit, a composite unit that selectively performs the composite process for the selected picture by the composite selection unit, and a position specifying composite unit that selectively specifies and combines picture positions for the pictures selected from the composite selection unit by using the pictures combined in the composite unit.

An example will be described in the case where the picture to be processed in composition by the composite unit is different from that processed in that by the position specifying composite unit.

An example clearly understood for a user will be described in the case where a display device is provided for displaying the picture selected by the composite selection unit, the composite picture on composite steps, and the picture combined or not combined as a result of the composition.

In the above-mentioned composite picture forming method, the pattern attribute contained in the overlapping domains among all of the pictures to be targeted for the composition is detected by using the design data and the picture data stored in a picture memory, before the composition, to form pattern attribute data of the respective overlapping domains. The pattern attribute is divided into a pattern for which a composite position is determined in both an x-direction and a y-direction, a pattern for which the composite position is determined in the x-direction alone, a pattern for which the composite position is determined in the y-direction alone, and a pattern for which the composite position is not determined in both the x- and y-direction.

First, the picture in the overlapping domain for which the composite position is determined in both the x- and y-direction is only selected to then combine it by using the pattern attribute of the respective overlapping domains. The composition of picture in the overlapping domain, for which the composite position is determined in all of the x-direction and y-direction, is performed to then finish an initial composition. After finishing the initial composition, there is a case where all of the pictures are combined to one in response to the pattern attribute, but there is also a case of dividing into a plurality of composite pictures combined with one or more pictures, and there is further a case where a single picture, which cannot be combined with any adjacent pictures, is present.

When all of the pictures cannot be combined to one at the initial composition, the presence of picture to be able to combine is further detected by using the pattern attribute for the composite picture containing a single picture after the initial composition.

In the initial composition, the pattern attribute to be detected is focused attention on each of the overlapping domains. In the detection after the initial composition, the pattern attribute is detected by using two overlapping domains. One of the pattern attributes to be detected is set to a pattern attribute for which a position is determined in the x-direction, and the other thereof is set to a pattern attribute for which a position is determined in the y-direction. In the view from between the composite pictures containing an adjacent single picture, the composite picture has a plurality of overlapping domains. If both the pattern attributes for determining respectively the positions in the x-direction and y-direction are contained in the plurality of overlapping domains, it judges that the composition between the composite pictures containing the single picture can be performed. The composition is then performed for between the composite pictures alone containing the single picture to be able to combine. Since there could be a plurality of overlapping domains by using the after composite picture, it is also possible to contain the pattern attributes for determining respectively the positions in both the x- and y-direction in the plurality of overlapping domains. To this end, the detection of pattern attribute using the plurality of overlapping domains is performed repeatedly, and the composition is also performed repeatedly for between the composite pictures alone containing the detected single picture, subsequently to the initial composition. The composite process is finished when there is no overlapping domain containing the pattern attributes for determining respectively the positions in both the x- and y-direction between all of the composite pictures containing the single picture. The above-mentioned process can be performed in high speed since the composition is performed for the detected pattern attribute alone, rather than a technique performed for while considering an entire consistency. Further, the picture of which the composite position can be specified clearly is discriminated by using the pattern attribute. The picture is then arranged in the order of easily specifying the composite position, so that the composition for more pictures can be performed by using information for the plurality of overlapping domains of the composite pictures which are already combined.

Hereinafter, the following description will be concerned with an apparatus for forming the composite picture, a system, and a computer program (or a storage medium for storing the computer program) executed in the apparatus or system, with reference to the drawings. More specifically, the description will be concerned with an apparatus including a critical dimension-scanning electron microscope (CD-SEM) as one of measuring devices, the system, and the computer program executed thereby.

The following-mentioned composite picture forming method is applicable not only to a device for measuring a pattern size, but also to a device for inspecting a pattern drawback. In addition, in the following description, a charged particle radiation device is shown as a device for forming pictures, and the SEM will be described as an example for that device. This is not limited to these devices thereto. A focused ion beam (FIB) device, which forms a picture on a sample by scanning ion beam, may be employed as the charged particle radiation device. In this regard, it is desirable to use the SEM rather than FIB device in consideration of a resolution in general, since an extremely high magnification ratio is demanded for measuring the fine pattern in high accuracy.

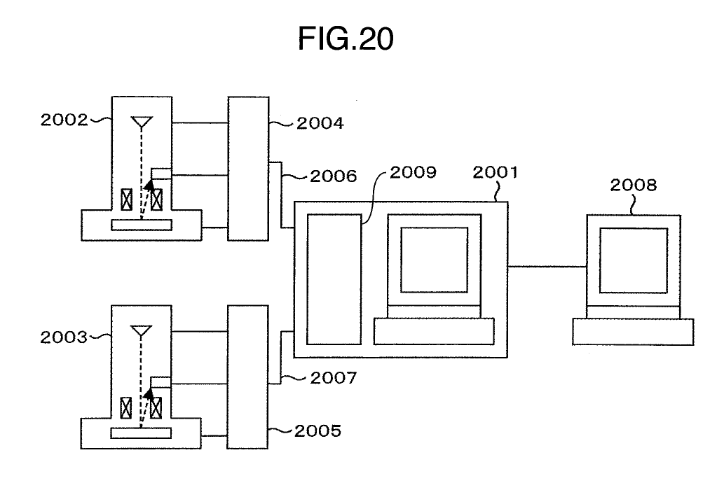

FIG. 20 is a diagram showing a system connected with a plurality of SEMs in center on a data management unit 2001. Particularly, in this embodiment, a SEM 2002 is used for measuring and inspecting patterns for a photomask and a reticle for use mainly in the semiconductor exposure process. A SEM 2003 is used for measuring and inspecting patterns transferred on a semiconductor wafer by an exposure with use of the above-mentioned photomask etc. The SEMs 2002, 2003 have no major difference between them in a basic configuration as an electron microscope, but they have a configuration corresponding to differences of the size of semiconductor wafer and photomask and a resistance characteristic against an electrification.

Control units 2004, 2005 are connected respectively with the SEMs 2002, 2003 to control the SEMs as required. Electron beam emitted from an electron source is focused by a multiple lens in the SEMs, and the focused electron beam is scanned one- or two-dimensionally on the sample by a scan deflection device.

A secondary electron (SE) and a backscattered electron (BSE) emitted from the sample by scanning the electron beam are detected by a detector to then be synchronized with the scanning in the scan deflection device and stored in a storage medium such as a frame memory etc. A picture signal stored in the frame memory is accumulated by a computation device incorporated in the controllers 2004, 2005. The scanning performed by the scan deflection device can be used for any sizes, positions and directions.

The above-mentioned controls etc. are performed in the controllers 2004, 2005 of the SEMs. As a result of scanning the electron beam, the acquired picture and signal are sent to the data management unit 2001 via communication lines 2006, 2007. In addition, as described in this embodiment, the controllers 2004, 2005 for controlling the SEMs are provided separately from the data management unit 2001 for performing the measurement on the basis of the signal acquired from the SEM. This is not limited to the above-mentioned configuration. The control and the measuring process for the SEM may be performed collectively in the data management unit 2001, and the controllers 2004, 2005 may also perform both the control and measuring process for SEMs.

The above-mentioned data management unit 2001 or controllers 2004, 2005 store a computer program for executing the measuring process to perform the measurement and computation in accordance with the computer program. Further, the data management unit 2001 stores design data for the photomask (sometimes referred to as a mask) and wafer for use in semiconductor manufacturing steps. The design data is represented by a GDS format, OASIS format or the like to be stored as a predetermined format, for example. In addition, software indicating the design data represents a format thereof, and any types of design data can be acceptable if it is handled as graphic data. Further, the design data may be stored in a storage medium separately provided from the data management unit 2001 in advance.

The data management unit 2001 provides a function to form the computer program (recipe) for controlling the operation of SEM on the basis of the design data of semiconductor device, and this function acts as a recipe setting unit. Specifically, a position etc. is set for performing a necessary process for the SEM, such as the design data, contour data of the pattern, a desired measurement point on the simulation applied design data, an autofocus, an autostigma, an addressing point, etc., and the computer program is written on the basis of the above-mentioned setting, for automatically controlling a sample stage of the SEM, the scan deflection device, etc. In addition, a template matching method using a reference picture referred to as a template is a technique, in which the template is moved in a search area for searching a desired place, to specify a place having a highest coincidence degree with the template or having a coincidence degree equal to or greater than a predetermined value in the search area. The controllers 2004, 2005 perform a pattern matching on the basis of the template which is one of recipe registered information. The controllers 2004, 2005 store a computer program for executing the pattern matching using a normalized correlation method etc.

A computation device 2009 is provided in the data management unit 2001 and the computation device 2009 can form composite pictures.

In addition, a focused ion beam unit may be connected to the data management unit 2001, for irradiating helium ion, liquid metal ion etc. on the sample. A simulator 2008 may be connected to the data management unit 2001, for simulating the pattern finish on the basis of the design data to turn a simulation picture acquired from the simulator 2008 into the GDS format and use it instead of the design data.

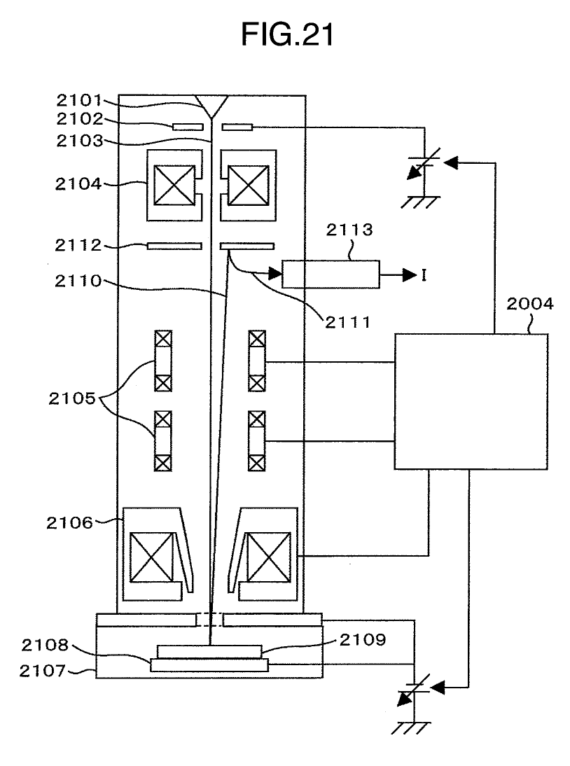

FIG. 21 is a schematic configuration diagram showing an electron scanning microscope. An electron beam 2103 extracted from an electron source 2101 by an extraction electrode 2102 and accelerated by an acceleration electrode (not shown) is narrow down by a condenser lens 2104 as a type of focusing lens to then be scanned one- or two-dimensionally on a sample 2109 by a scan deflection device 2105. The electron beam 2103 is decelerated by a negative voltage applied to an electrode incorporated in a sample stage 2108 to be focused by acting an objective lens 2106 and irradiated on the sample 2109.

The electron beam 2103 is irradiated on the sample 2109 to thereby emit an electron 2110, such as a secondary electron and a backscattered electron from an irradiated place. The emitted electron 2110 is accelerated in an electron source direction by an accelerating action on the basis of the negative voltage applied to the sample to then be collided to a transform electrode 2112 and generate a secondary electron 2111. The secondary electron 2111 emitted from the transform electrode 2112 is picked up by a detector 2113, and an output I of the detector 2113 is varied in response to an amount of the picked up secondary electron. A luminance of a display unit (not shown) is varied in response to the output “I”. For example, when forming a two-dimensional image, a deflection signal supplied to the scan deflection device 2105 is synchronized with the output “I” from the detector 2113 to form a picture of a scanning domain. The electron scanning microscope shown in FIG. 21 provides a deflection device (not shown) to be moved on the scanning domain of the electron beam. This deflection device is used for forming an identically shaped pattern picture etc. present in difference positions. This deflection device is also referred to as an image shift deflection device, and it can be moved on a position of field of view (FOV) in the electron microscope without moving the sample on the sample stage. In this embodiment, the deflection device is used for positioning the FOV in the domain represented by a partial picture given to forming the composite picture. Further, the deflection device may include both the image shift deflection device and the scanning deflection device to superimpose the signals used for the image shift and the scanning and then supply to the deflection device.

In addition, FIG. 21 illustrates an example in which the electron emitted from the sample is transformed by the transform electrode once to then be detected. This is not however limited to such configuration. For example, it is possible to configure that an electron multiplier tube and a detecting surface of a detector are arranged on an orbit of the accelerated electron.

The controller 2004 provides a function for controlling the parts of electron scanning microscope and forming the picture on the basis of a detected electron and also provides a function for measuring a pattern width of the pattern formed on the sample on the basis of a detected electron intensity distribution referred to as a line profile. In addition, a composite picture forming as after-mentioned may be performed in the data management unit 2001 and also performed in the controllers 2004, 2005. Further, a part of the process necessary for the composite picture forming may be performed in one computation device and the other of the process may be performed in the other computation device. Furthermore, a partial picture processed to the composite picture forming may be registered on a frame memory incorporated in the controllers 2004, 2005 in advance, and also stored in a memory incorporated in the data management unit 2001 and an externally installed storage medium.

Hereinafter, the following description will be concerned with a composite picture forming method and a picture forming apparatus of the same on the basis of the picture imaged by an imaging device such as the charged particle radiation device etc.

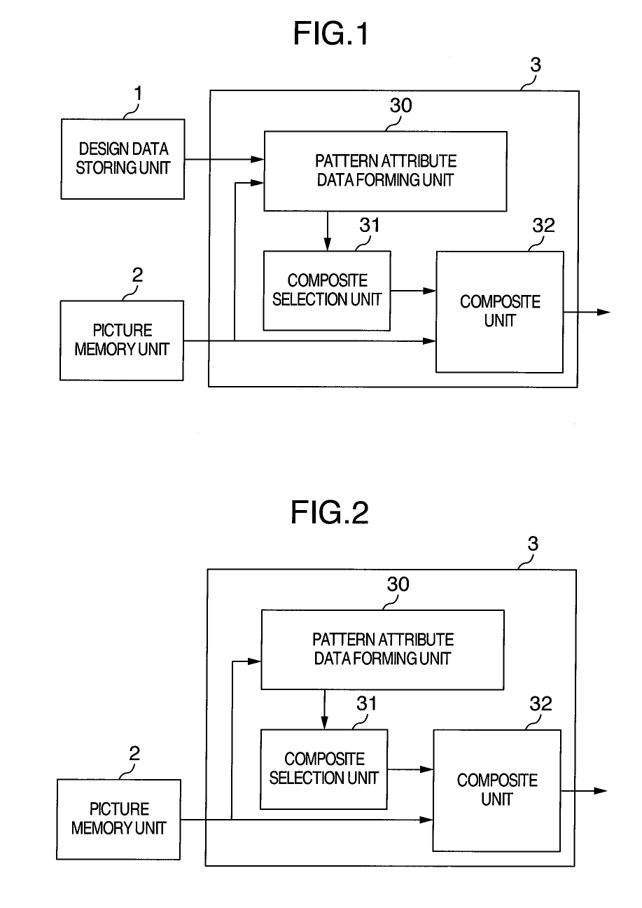

FIG. 1 is an explanatory diagram showing an example of the composite picture forming apparatus. In this embodiment, a design data storing unit 1, a picture memory unit 2 and a picture forming unit 3 will be described in correspondence to the storage medium and computation device in the data management unit 2001 shown in FIG. 20. This is not however limited to the above-mentioned configuration, and the composite picture forming can also be performed by using other storage medium and computation device.

First, both the design data of the electronic device pattern stored in the design data storing unit 1 is entered into a pattern attribute data forming unit 30 in the picture forming unit 3, and the picture data of the electronic device pattern acquired from the SEMs 2002 and 2003 and stored in the picture memory unit 2 is also entered into the same.

The pattern attribute data forming unit 30 uses the design data and the pieces of picture data of the electronic device pattern to form pattern attribute data of the pattern present in the overlapping domain of the picture data. The pictures to be combined in the composite selection unit 31 are selected on the basis of the pattern attribute data formed by the pattern attribute data forming unit 30, when combining the pictures. The picture data, stored in the picture memory unit 2, only corresponding to the selected pictures in the composite selection unit 31 is combined by a composite unit 32.

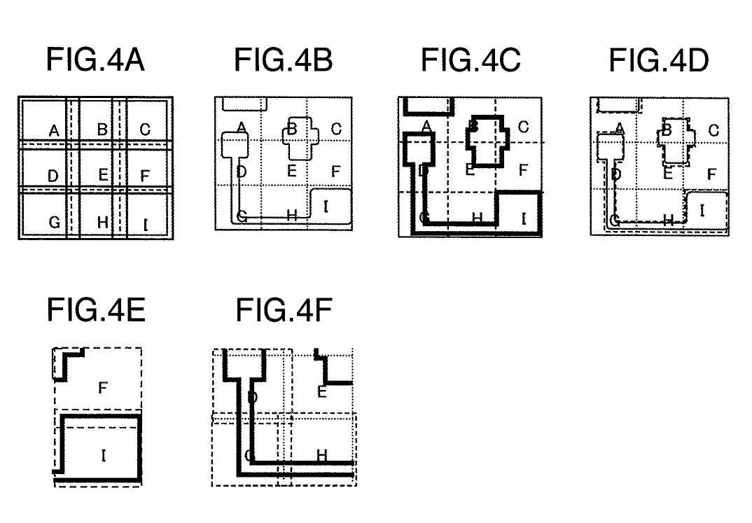

The following description will be concerned with the picture composition of the electronic device pattern with reference to FIGS. 4A to 4F. Here, the description will be concerned with the case where nine pieces of divided pattern pictures are combined to one piece. When an imaging range is divided by a dotted line into nine to be set to domains A to I indicating nine pieces as shown in FIG. 4A, the nine pieces are imaged such that an adjacent picture domain is overlapped to one another so as to have an equal to or greater than predetermined size. The electron device pattern to be imaged is mostly a linearly monotone pattern as shown in FIG. 4B. Further, since the electronic device pattern is formed on the basis of the design data, imaged design data corresponding to a position of the electronic device pattern in FIG. 4B should be a picture having identical shape as shown in FIG. 4C. The design data is imaged to a picture having line segments and a background alone. For example, a picture image superimposed a picture drawn by the design data corresponding to a picture position on the picture data of the electronic device pattern becomes a pattern shown in FIG. 4D.

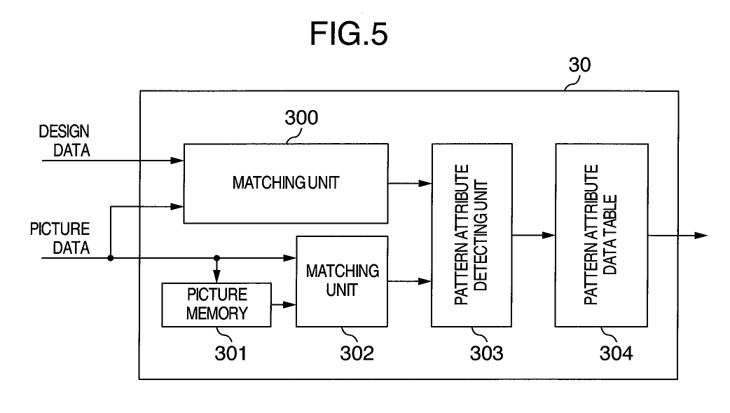

Here, FIG. 5 is a diagram showing the pattern attribute data forming unit 30. The pattern attribute data forming unit 30 forms a pattern attribute present in the overlapping domain between the pictures. A matching unit 300 performs a matching operation between the picture data drawing the design data and the picture data of the imaged electronic device pattern to determine a corresponding position of the design data and the imaged picture data. Even though the design data is not completely matched with the picture data such that they are matched as shown in FIG. 4D, an expanding process is applied to the pattern to be able to match roughly with each other and determine the corresponding position. Vertical and horizontal line segment information of the pattern contained in the overlapping domain between the adjacent pictures on the design data is acquired from the corresponding position. For example, it understands that the vertical and horizontal line segments are contained in the overlapping domains “F” and “I” in FIG. 4E. It also understands that the vertical line segment alone is contained in the overlapping domains “D” and “G” in FIG. 4F and the horizontal line segment alone is contained in the overlapping domains “G” and “H”. The line segment can be acquired from calculation for the number of pixels individually configuring the vertical, horizontal and oblique directions.

Further, a matching unit 302 makes a picture memory 301 store the picture data adjacent to the pictures, and performs matching with the adjacent pictures by using the overlapping domains.

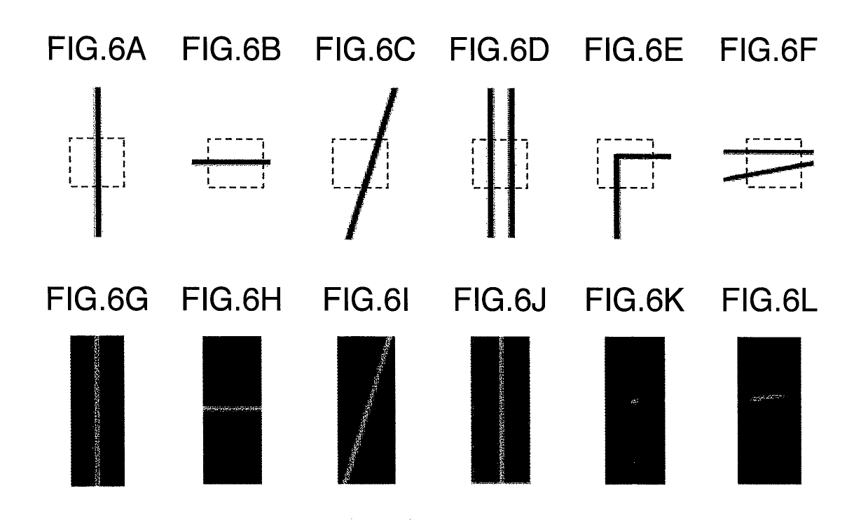

Here, FIGS. 6A to 6L show an autocorrelation picture for various line segment pictures. A correlation pictures, performed the autocorrelation as rectangular domains inside the dotted line are a template for the line segment picture shown in FIGS. 6A to 6F, becomes represented to FIGS. 6G to 6L. The vertical line in FIG. 6G indicates that a peak value of the correlation continues in the vertical direction, therefore, a coordinate of the peak value of the correlation is determined in the x-direction, but not determined in the y-direction. The horizontal line in FIG. 6H indicates that the peak value of the correlation continues in the horizontal direction, therefore, the coordinate of the peak value of the correlation is determined in the y-direction, but not determined in the x-direction. The oblique line in FIG. 6I indicates that the peak value of the correlation continues in the oblique direction, therefore, the coordinate or coordinate position of the peak value of the correlation is not determined in both the x- and y-direction. However, when either the x- or y-direction is determined, either one is determined. Even in two line segments in FIG. 6J, the peak value of the correlation continues similarly in the direction if the two line segments are in the same direction.

However, when the two line segments are toward a different direction as shown in FIGS. 6K and 6L, the peak value of the correlation becomes one point to be able to determine the coordinate position. In consideration of the correlation picture, a pattern shape can also be presumed roughly by seeing the shape around the peak of the correlation picture. In fact, the attribute of the vertical pattern to be determined in the x-direction alone in FIG. 6A can be presumed if the pattern shape becomes the correlation picture in FIG. 6G. The attribute of the horizontal pattern to be determined in the y-direction alone in FIG. 6B can be presumed if the pattern shape becomes the correlation picture in FIG. 6H. The attribute of the vertical and horizontal pattern to be determined in both the x- and y-direction can be presumed if the correlation peak position is determined as one point as the correlation picture shown in FIGS. 6K and 6L.

Here, the matching unit 302 determines a shape of a correlated distribution around the correlation peak, on the basis of the determined correlation information, to discriminate the pattern shape contained in the overlapping domain of the imaged picture. A pattern attribute determining unit 303 determines the pattern attribute of a targeted overlapping domain by using results of the matching units 300, 302. When the vertical and horizontal line segment information contained in the overlapping domain based on the design data in the result of the matching unit 300 is matched with the pattern shape determined from the shape around the peak of the correlation picture in the matching unit 302, the pattern attribute is determined on the basis of the line segment information of the result in the matching unit 300. When that is not matched with the pattern shape in the above-mentioned case, it can be thought that the attribute is handled as having no pattern in both vertical and horizontal line segments.

It can also be thought that the types of pattern attribute are divided into: the vertical and horizontal pattern by which a composite position is determined in both the x- and y-direction; the vertical pattern by which the composite position is determined in the x-direction alone; the horizontal pattern by which the composite position is determined in the y-direction alone; the oblique pattern by which the composite position is determined in both the x- and y-direction if the position is determined in either the x- or y-direction; and there is no pattern itself. In the case of reviewing the line segments described in FIGS. 6A to 6L, It can be thought that the types of pattern attribute are divided into: FIG. 6A indicates the attribute of the vertical pattern to be determined in the x-direction alone, FIG. 6B indicates the attribute of the horizontal pattern to be determined in the y-direction alone, FIG. 6C indicates the attribute of the oblique pattern, FIG. 6D indicates the attribute of the vertical pattern, FIG. 6E indicates the attribute of the vertical and horizontal pattern to be determined in the x- and y-direction, and FIG. 6F indicates no vertical pattern, but to be determined in both the x- and y-direction, therefore, indicates the attribute of the vertical and horizontal pattern to be determined in both the x- and y-direction. Further, it can be thought that the types of pattern attribute are made increased and the pattern attribute is divided in every line segment direction also containing the oblique direction for various angles.

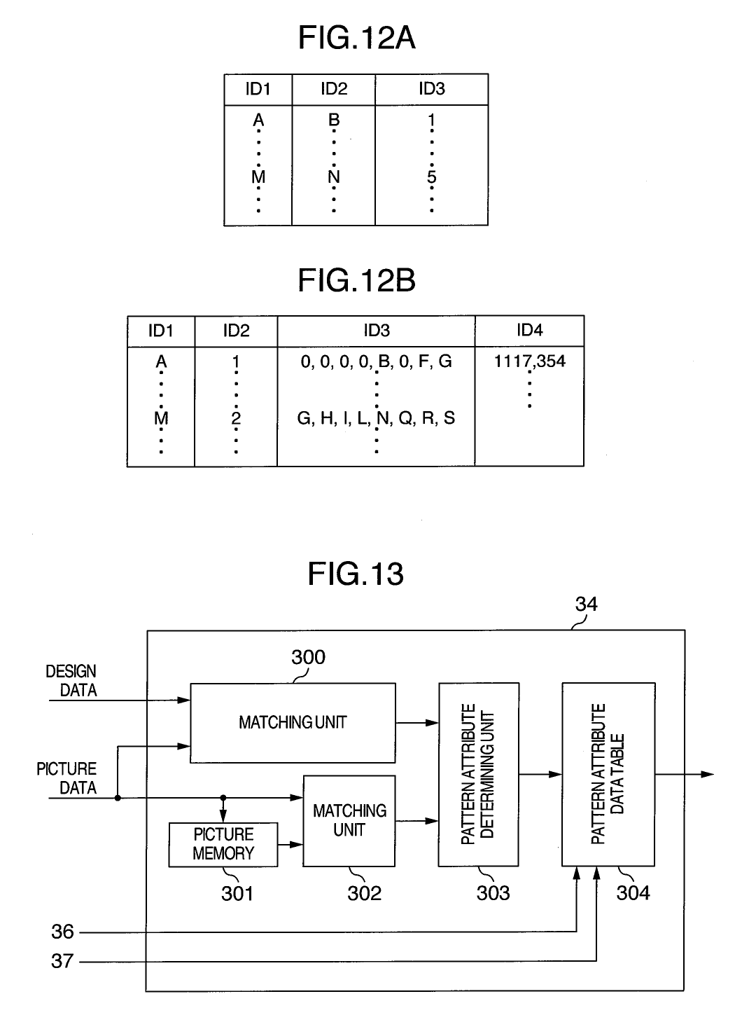

The pattern attribute determined in the pattern attribute determining unit 303 is stored in a pattern attribute data table 304 for every overlapping domain. The pattern attribute for all of the overlapping domains of the pictures to be targeted for the process is determined to then store in the pattern attribute data table 304. For example, as shown in FIG. 12A, pattern attributes ID1, ID2 and ID3 of the overlapping domain are stored respectively in addresses corresponding to picture numbers. In this embodiment, the description has been concerned with the method of such that the pattern attribute determining unit 303 determines the pattern attribute in accordance with the output of both the matching unit 300 and 302, but it may determine the pattern attribute itself output from the matching unit 300 without using the matching unit 302. The pattern attribute determining unit 303 also determines the pattern attribute itself presumed by the matching unit 302 without using the matching unit 300. At this time, it can be thought that the pattern attribute may be determined without using the design data stored in the design data storing unit 1 in FIG. 2. The matching operation in the matching units 300, 302 can be performed by using a matching method of a generally used normalized correlation method.

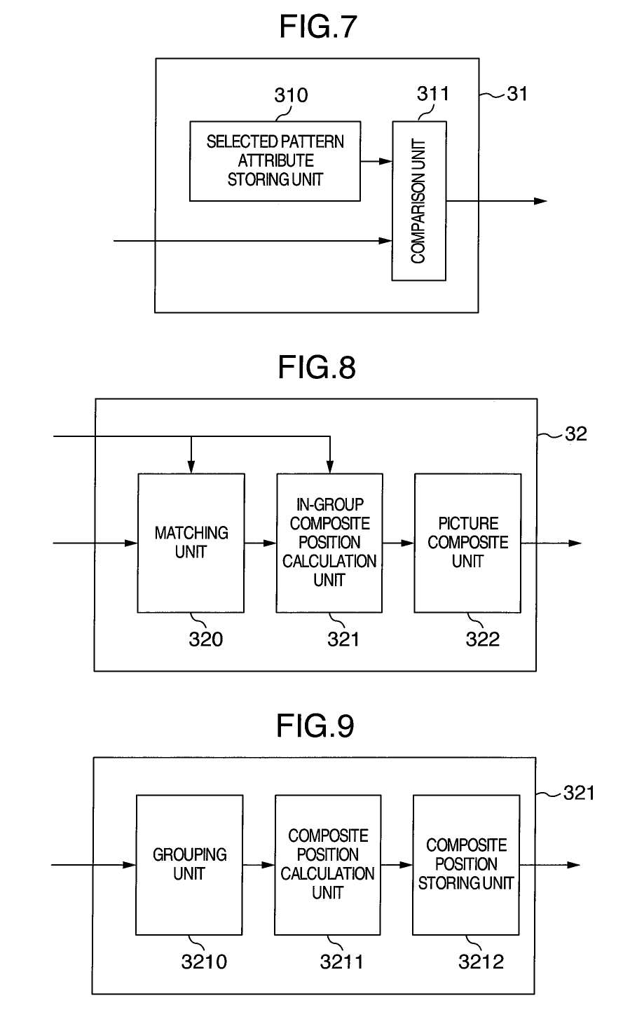

FIG. 7 shows the composite selection unit 31 in this embodiment. When a composite process starts, the pattern attribute data is read out from the pattern attribute data forming unit 30 in sequence for the overlapping domains to be processed, and the read out pattern attribute data is compared with the pattern attribute stored in a selected pattern attribute storing unit 310 in advance by a comparison unit 311. A signal for permitting the composition is output to the composite unit 32 when both the pattern attributes are matched with each other.

In this embodiment, the attribute of the vertical and horizontal pattern to be determined in the x- and y-direction is set in the selected pattern attribute storing unit 310 in advance. The signal for permitting the composition is output only when the attribute of the vertical and horizontal pattern to be determined in both the x- and y-direction is contained in the overlapping domain to be targeted for the process. In this embodiment, the description is targeted to the picture of which a longitudinal direction of two line segments is the x- and y-direction, as an example of the picture to be able to determine the coordinate position. However, since the coordinate position can be specified if at least one of two line segments is directed toward a different direction, the picture containing two line segments of +45 degree and −45 degree may be acceptable when the x-direction is set to 0 degree, for example.

As mentioned above, the necessity of composition is judged in response to the pattern attribute, therefore, it is possible to selectively combine the easily combined pictures in the picture process, so that the composition can be realized in high accuracy. Further, as after-mentioned, the composition is performed selectively between the pictures satisfying a predetermined condition, and the composition between the composite pictures acquired from the above-mentioned composition is also performed separately, so that the picture composition can be performed while a coupling error is inhibited, in the combined picture as a whole.

FIG. 8 shows the composite unit 32 in the embodiment. Only when the output of composite selection unit 31 indicates a permission of the composition for the picture data of the overlapping domain between the pictures to be targeted for the process, the matching unit 320 performs the matching process. The matching unit 320 performs the matching by using the generally used normalized correlation method. Further, since the matching is already performed for the picture data of the overlapping domain between the respective pictures when forming the pattern attribute data, the position of matching is memorized in advance and this matching position may be used instead of the output of the matching unit 320.

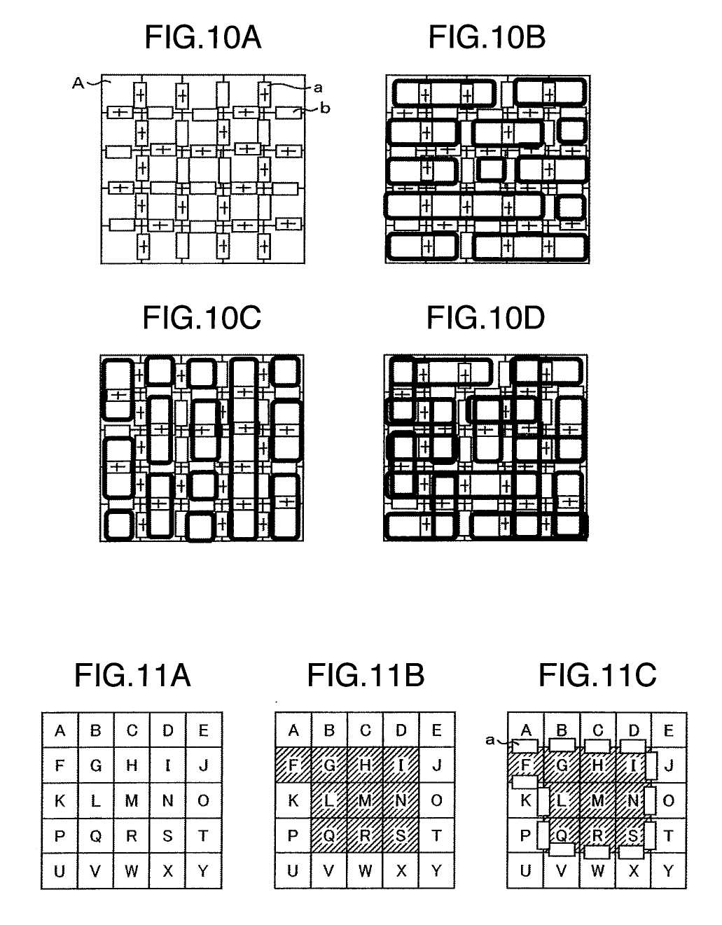

Next, FIG. 9 shows an in-group composite position calculation unit 321 in the embodiment. In the in-group composite position calculation unit 321, a grouping unit 3210 makes the pictures grouped for every picture to be able to combine between the adjacent pictures only when the output of composite selection unit 31 indicates the permission of the composition between the targeted pictures. FIGS. 10A to 10D show an outline of grouping the pictures in the grouping unit 3210.

FIG. 10A shows a picture arrangement and the overlapping domains between the pictures configured vertically and horizontally by 5×5=25 pieces. Here, the picture arrangement may use the corresponding position corresponding to the design data and the imaged picture data determined by the pattern attribute data forming unit 30, and may also be supplied from an outside. Further, the picture arrangement may be determined from the corresponding position acquired from the matching between the pictures. A character “A” in FIG. 10A indicates one piece of picture, the overlapping domain (cross in rectangle) “a” indicates that the output of composite selection unit 31 indicates the permission of composition, and the overlapping domain (blank in rectangle) “b” indicates that the composition is not permitted.

When grouping the 25 pieces of pictures, first, the-between pictures of overlapping domain to be permitted for the composition in the horizontal direction (first direction) are grouped, that is, the pictures enclosed by the thick-lined rectangle in FIG. 10B are set to one group. Here, there are 12 groups in FIG. 10B. Likewise, the pictures are grouped in the vertical direction (second direction) to make 14 groups as shown in FIG. 10C. The groups in the horizontal direction are superimposed with the groups in the vertical direction to make an arrangement shown in FIG. 10D. In consequence, the groups can be grouped into one in this case.

As mentioned above, in plural directions, the picture composition is performed on the basis of the determination of whether the overlapping domain between the pictures to be targeted for the composition is satisfied for a predetermined condition and the picture composition is further performed, so that it is possible to arrange the pictures to be targeted for the composition on the appropriate position, in the composition pictures as a whole.

In addition, the groups are grouped into one in this embodiment, but can be grouped into a plurality of groups. Subsequently, the composite position of the pictures in the group is determined for every group grouped by the grouping unit 3210, by a composite position calculation unit 3211. The composite position of the picture based on either picture in the group and the adjacent picture becomes the corresponding position determined by the matching. When the corresponding position is of the adjacent picture of the picture of which the composite position is previously determined, the composite position becomes a position added the corresponding position determined by the matching to the previously determined composite position. Likewise to continuously determine the composite position, and all of the picture positions in the group are determined. When the group is present in plural numbers, the composite position of the pictures in the group is determined likewise for all of the groups.

Group information, belonging to the pictures, determined by the composite position calculation unit 3211 and the composite position of the respective pictures for every group, are stored in a composite position storing unit 3212. The composite position storing unit 3212 is realized by a memory. For example, when 25 pieces of picture represented from “A” to “Y” are arranged in FIG. 11A, it is assumed that the pictures are grouped into a first group consisting of the pictures A, B, C, D, E, J, K, O, P, T, U, V, W, X, Y and a second group consisting of the pictures F, H, I, L, M, N, Q, R, S. In this case, a memory in the composite position storing unit 3212 stores a group number (here, the first group is set to “1” and the second group is set to “2”) in corresponding addresses to a picture name ID1 as shown in FIG. 12B and a picture name adjacent to the targeted pictures in eight directions. It can be thought that the memory stores eight pieces of the picture name in sequence from the upper-left to the lower-right and stores “0” when there is no corresponding picture. The x- and y-coordinate value is stored in a composite position ID4 of the picture in the group.

In this case, the picture “A” corresponds to an address “1” in a group number ID2 and the picture names adjacent to the pictures in eight directions become 0, 0, 0, 0, B, 0, F, G. The picture “M” corresponds to an address “2” in a group number ID2 and the picture names adjacent to the pictures in eight directions become H, I, L, N, Q, R, S in series. When the group is present in plural numbers, the picture to be reference is present in every group. For that reason, it is necessary to determine a relative position of the picture to be reference in the respective groups. Therefore, the design data formed in the pattern attribute data forming unit 30 is stored, and the corresponding position determined by the matching of the respective pieces of picture data is also stored in advance. It can be thought that the corresponding position on the design data of the picture to be reference in the groups is read out to determine the relative position. However, the corresponding position becomes rough since the design data is not matched completely with the respective pieces of picture data.

A picture composite unit 322 combines the pictures at the composite position of the respective pictures output from the in-group composite position calculation unit 321. It can be thought that the pictures are overwritten on the composite position in the composite unit 32, and it can also be thought that a blend process of the pixel values is performed around the composite position of the pictures to make a boundary obscure.

However, the pictures are grouped into a plurality of groups in the in-group composite position calculation unit 321 of the composite unit 32, in consequence, it is possible to occur a displacement since the composite pictures are also divided into plural number. For this reason, it is necessary to preferably reduce the number of groups. Consequently, the pictures to be able to combine are grouped by using the pattern attribute data to apply the technique to the determination of the composite position, after that, the corresponding position between the groups is again determined by using the pattern attribute data. This technique will be described below.

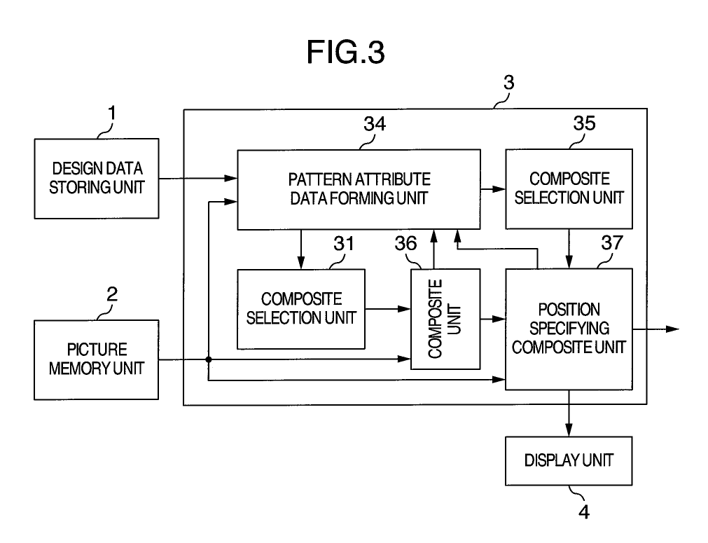

FIG. 3 is an explanatory diagram showing one example of a composite picture forming apparatus for performing the composite process in plural times by using the pattern attribute data. First, the design data of the electronic device pattern stored in the design data storing unit 1 is entered into a pattern attribute data forming unit 34 in the picture forming unit 3, and the picture data of the electronic device pattern acquired by the SEMs 2002, 2003 etc. and stored in the picture memory unit 2 is also entered into the pattern attribute data forming unit 34.

The pattern attribute data forming unit 34 forms the pattern attribute data present in the overlapping domain of the picture data by using the design data and the pieces of picture data of the electronic device pattern. At a time of the composition, the picture to be combined in the composite selection unit 31 is selected on the basis of the pattern attribute data formed by the pattern attribute data forming unit 34. The group information indicating to be able to combine the respective pictures in a composite unit 36 and the composite position of the respective pictures in the group are determined only for the picture data in the picture memory unit 2 corresponding to the picture selected by the composite selection unit 31.

The composite picture forming apparatus in FIG. 1 applies the composite process to the after determined composite position. However, the pattern attribute data corresponding to the plurality of overlapping domains of the pictures adjacent to between the respective groups is output to a composite selection unit 35 by using the group information belonging to the respective pictures determined by the pattern attribute data forming unit 34, in this case. For the plurality of overlapping domains of the pictures adjacent to between the respective groups, the composite selection unit 35 detects whether there is a combination of a specific pattern attribute data, to then output a detected result to a position specifying composite unit 37. The position specifying composite unit 37 specifies the corresponding position between the targeted groups to determine the composite position if there is the combination of the specified pattern attribute data. For the plurality of overlapping domains of the pictures adjacent to among all of the groups, the corresponding position among the groups is specified repeatedly to determine the composite position until the combination of the specified pattern attribute data is disappeared.

FIG. 13 shows the pattern attribute data forming unit 34 in the embodiment. This is partially common to the pattern attribute data forming unit 30 in FIG. 5. However, in this case, the pattern attribute data between the targeted pictures corresponding to the address indicated by the composite unit 36 and position specifying composite unit 37 can be read out from the pattern attribute data table 304.

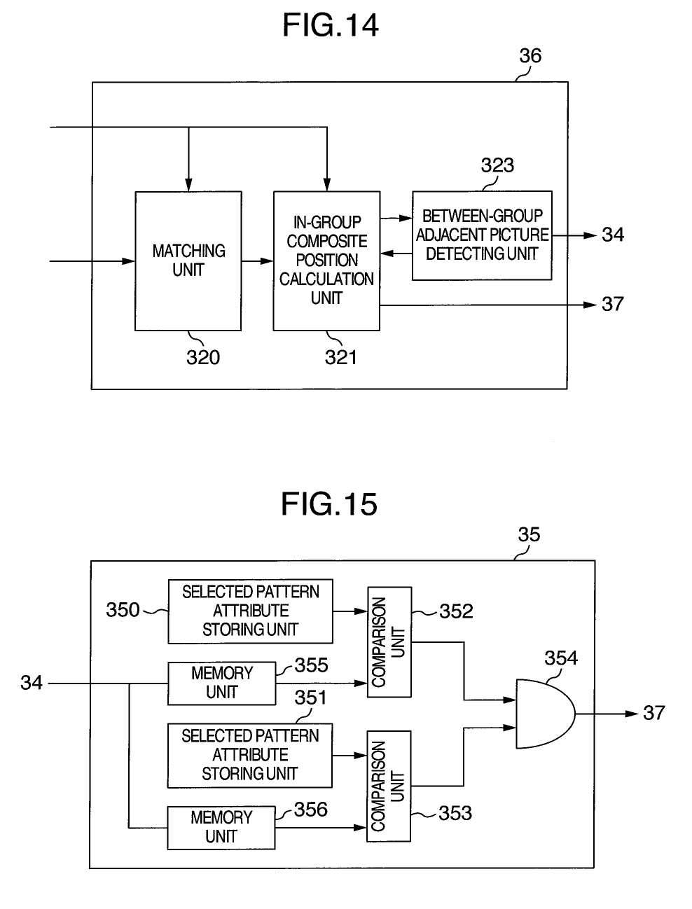

FIG. 14 shows the composite unit 36 in the picture forming unit 3 in FIG. 3. The composite unit 36 provides a between-group adjacent picture detecting unit 323 in place of the picture composite unit 322 of the composite unit 32 in FIG. 8. The between-group adjacent picture detecting unit 323 detects the picture adjacent to between the groups on the basis of the group number information determined in the in-group composite position calculation unit 321 and the information regarding the picture data of the adjacent pictures in the eight directions.

For example, as shown in FIG. 11B illustrated by the grouping unit 3210, it is assumed that the groups are divided into the first group to which the pictures A, B, C, D, E, J, K, O, P, T, U, W, X, Y are belonged and the second group to which the pictures F, H, I, L, M, N, Q, R, S are belonged. When the adjacent pictures are present in the vertical and horizontal direction alone, the adjacent pictures in the first and second group are A and F, B and C and H, D and I, J and I, O and N, T and S, X and S, W and R, V and Q, P and Q, K and L, K and F. For the sake of simple description, the adjacent pictures have been set in the vertical and horizontal direction alone in this embodiment, but the overlapping domain in the oblique direction may also be seen. A pair of pictures adjacent to between groups is determined for every between groups to be output to the pattern attribute data forming unit 34. The pattern attribute data forming unit 34 determines the pattern attribute data corresponding to the overlapping domain of the pictures adjacent to between the targeted groups from the already formed pattern attribute data table 304. For example, as shown in FIG. 11C, a domain between adjacent pictures of between the first group and second group is set to an overlapping domain “a”.

When the overlapping domain between the groups is present in plural numbers, the pattern attribute data corresponding to the plurality of overlapping domains is determined. The pattern attribute data between the pictures adjacent to between the determined groups is entered into the composite selection unit 35.

FIG. 15 shows the composite selection unit 35 in the embodiment. In the composite selection unit 35, a comparison unit 352 compares the pattern attribute data entered from the pattern attribute data forming unit 34 with the pattern attribute information set in a selected pattern attribute storing unit 350. Further, a comparison unit 353 compares the entered pattern attribute data with the pattern attribute information set in a selected pattern attribute storing unit 351.

The comparators 352, 353 are set so as to output “1” when matching the pieces of pattern attribute data to be compared. The output of an AND circuit 354 becomes “1” in response to the matching of the pattern attribute data to be output as “1” to the specified position composite unit 37.

When the output of the comparison unit 352 and 353 becomes “1” and the pattern attribute data is matched with the stored attribute information, information regarding the attribute pattern at this time is stored in a memory and maintained for a time period during which the overlapping domain between the pictures in the same group is detected. For this reason, the order may be neglected, and a detection is performed for whether the pattern attribute set in both the selected pattern attribute storing units 350 and 351 is present in the pictures between the groups. The memory may be made clear when detecting the pattern attribute in a different group.

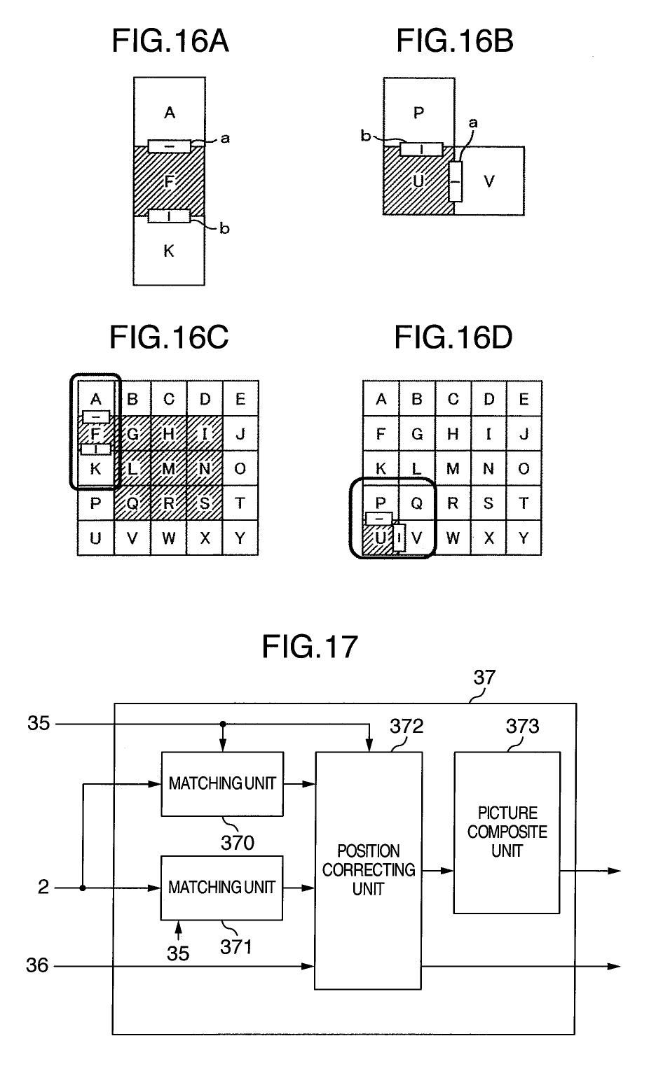

FIGS. 16A to 16D are an explanatory diagrams for explaining a technique to specify the relative position between the picture groups by using the pattern attribute data, when the plurality of overlapping domains are present between the picture groups. For example, as shown in FIGS. 16A and 16B, when the pictures are divided into the first group to which the pictures A, K, P, V are belonged and the second group to which the pictures F, U are belonged, the overlapping domain between the first group and second group becomes two or “a” and “b”. At this time, when the overlapping domain “a” corresponds to a horizontal line pattern to be able to specify the relative position in the y-direction and the overlapping domain “b” corresponds to a vertical line pattern to be able to specify the relative position in the x-direction, the relative position in the y-direction can be specified by the overlapping domain “a” and the relative position in the x-direction can be specified by the overlapping domain “b” in the first group and second group. Alternatively, if two overlapping domains necessary for specifying the relative position is known and the matching is performed for the two overlapping domains, a relative peak becomes one point to be able to determine the corresponding position.

As shown in FIG. 16C, when the pictures are divided into the first group to which the pictures A, B, C, D, E, J, K, O, P, T, U, W, X, Y are belonged and the second group to which the pictures F, H, I, L, M, N, Q, R, S are belonged, the relative positions of the first and second group are specified to be able to combine the both groups into one since the overlapping domain to be able to specify the relative position in the y-direction and the overlapping domain to be able to specify the relative position in the x-direction are contained between the pictures A, F, K. In also an example of FIG. 16D, since the relative position in the y-direction can be specified by the overlapping domain between the pictures P and U and the relative position in the x-direction can be specified by the overlapping domain between the pictures U and V, the group to which the pictures P, V are belonged can be combined with the picture U, in also this case. In addition, as shown in FIG. 16D, it is not necessarily to make one of the overlapping domains, which is targeted for the composite picture forming, grouped, and it is possible to use the above-mentioned relative position specifying technique even when performing the picture composition between the picture group and one piece of picture.

FIGS. 16A to 16D are illustrated by a technique for specifying the relative position in the plural directions from the plurality of overlapping domains regarding one picture. This is not limited thereto, but the relative position may be specified by using the attribute data of the plurality of overlapping domains between the plural pictures. In the example shown in FIG. 16C, the overlapping domain of the pictures D and I may be set to the overlapping domain “a”, but the overlapping domains of the pictures A and F are not set thereto. That is, the relative position in the y-direction may be specified by using the horizontal line pattern contained in the overlapping domain between the pictures D and I, and the relative position in the y-direction may be specified by using the vertical line pattern contained in the overlapping domain between the pictures F and K.

For a purpose of specifying the relative position between the above-mentioned picture groups or between the picture group and picture, it is desirable that the pattern attribute being set in the selected pattern attribute storing units 350, 351 in the composite selection unit 35 is made into the horizontal line pattern capable of specifying the relative position in the y-direction and the vertical line pattern capable of specifying the relative position in the x-direction. However, as assumption in this case, it is necessary to determine the composite position in the group containing the pictures A and K in FIG. 16A, and it is also necessary to determine the composite position in the group containing the pictures P and V in FIG. 16B.

FIG. 17 shows the specified position composite unit 37 in the embodiment. When the output of composite selection unit 35 is “1”, matching units 370, 371 perform the matching operation for two overlapping domains between the groups to be targeted. For example, the matching unit 370 performs matching the vertical line pattern to be determined in the x-direction to then determine the position in the x-direction. The matching unit 371 performs matching the horizontal line pattern to be determined in the y-direction to then determine the position in the y-direction. A position correcting unit 372 performs a position correction between the plural groups by using position information corresponding to the determined “x” and “y”. The matching units 370, 371 may use the normalized correlation method to perform the matching.

After determining the position information by the composite unit 36, information regarding the group number of the respective pictures stored in the composite position storing unit 3212, the adjacent picture name in the eight directions and the composite position in the group, are stored in the position correcting unit 372 in advance.

The groups to be targeted are made into one on the basis of specifying the relative position between the picture groups. When the groups are made into one, the corresponding position between the determined groups is added for the picture, to which the group is changed, to be able to correspond to the composite position of the changed group.

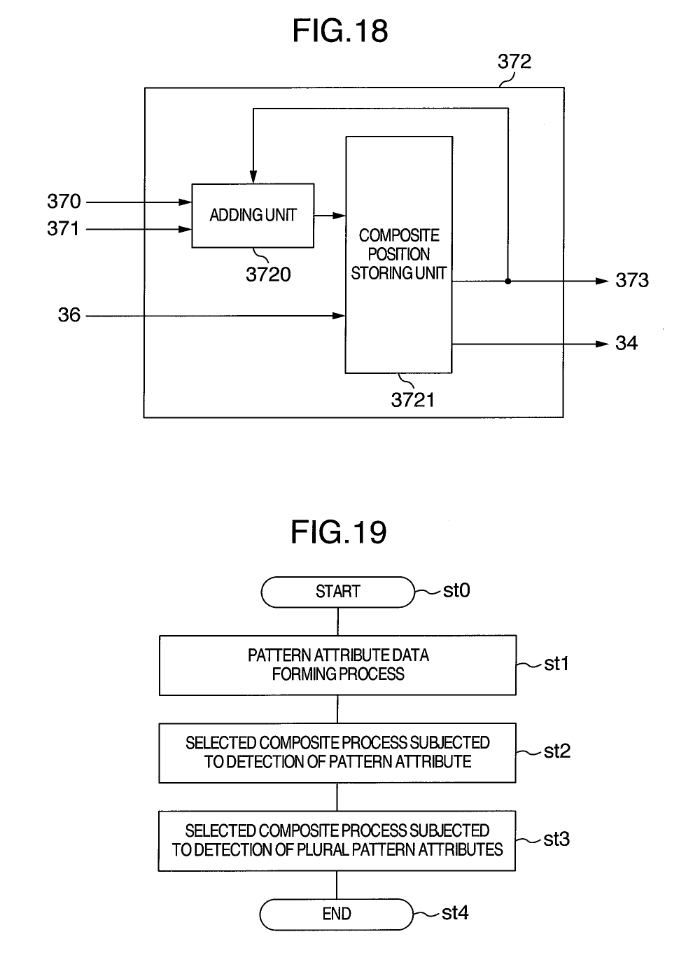

FIG. 18 shows the position correcting unit 372 in the embodiment. The composite position in the group corresponding to the picture to be targeted for change is read out for the picture group stored in a composite position storing unit 3721. The relative position between the groups determined by the matching units 370, 371 is added in the x- and y-direction by an adding unit 3720 to again store in the composite position storing unit 3721. At this time, the group number information is also changed. In this way, the output of composite selection unit 35 becomes “1” and the corresponding position between the targeted groups is determined by the position specifying composite unit 37, thereafter, the selection in the composite selection unit 35 is again repeated from between the initial groups.

When the output of composite selection unit 35 does not become “1” even though repeating all of between groups, a picture composite unit 373 combines the composite positions of the respective pictures at that point. The picture composite unit 373 is the same as picture composite unit 322 shown in FIG. 8.

Further, a display unit 4 may be provided to display the picture combined at the composite positions of the respective pictures at a time of fining the composition in the composite unit 36 and also display the picture to being grouped continuously in the position specifying composite unit 37. Further, a composite result may be displayed for a user who can see the picture on the composition, the picture to which the composition was applied or not applied.

FIG. 19 is a flowchart for explaining the picture composite process (panoramic process). First, the pattern attribute data forming is performed at a step st1 after starting the apparatus at a step st0. This process is executed by the pattern attribute data forming units 30, 34 as shown in FIG. 1 and FIG. 3, and the detail of pattern attribute data forming unit 30 is shown in FIG. 5. Subsequently, a selected composite process is performed at a step st2 in accordance with the detection of pattern attribute. This process corresponds to a series of the process from the pattern attribute data forming process to the end of process performed by the composite unit 36 illustrated in FIG. 3. The detail of this process has been described with reference to FIG. 7 to FIG. 14. Subsequently, the selected composite process is performed on the basis of the detection of the plural pattern attributes at a step st3. The detail of this process has described with reference to FIG. 13 and FIG. 15 to FIG. 18.

The above-mentioned picture forming unit 3 may be incorporated into the controllers 2004, 2005 or data management unit 2001. Further, the process performed in the picture forming unit 3 may be executed by software. In this case, the software process may also be executed by a personal computer, and the software may be incorporated in an LSI to perform a hardware process.

The picture of which the composite position is specified clearly is discriminated by using the pattern attribute of the overlapping domain between the pictures. In addition, the relative position is determined in sequence for easily specifying the composite position to perform the picture composition, and the picture composition is further performed by using the plurality of overlapping domains of the already combined composite pictures, so that more number of pictures can be combined.

In addition, the above-mentioned embodiment has described that the attribute data is appended to the overlapping domain between the pictures by using the design data, but this is not limited thereto. A template individually indicating a shape of patterns formed separately from the design data is provided in plural. The pattern matching in the overlapping domain is then performed by using the template. The pattern information of the template having the highest coincidence degree may be stored as the attribute data of the overlapping domain.

It should be further understood by those skilled in the art that although the foregoing description has been made on embodiments of the invention, the invention is not limited thereto and various changes and modifications may be made without departing from the spirit of the invention and the scope of the appended claims.

1. A composite picture forming method of providing pictures in a plurality of domains on a sample while providing an overlapping domain and superimposing a plurality of pictures on the overlapping domain provided for the plurality of pictures to perform a composition, comprising the steps of:
forming pattern attribute information contained in the overlapping domain in accordance with a line segment direction of a pattern contained in the overlapping domain;
selecting the pictures to be combined by using the pattern attribute information; and
combining the pictures selected.

2. The method according to claim 1 further comprising the step of: matching between design data of the sample and pattern data contained in the overlapping domain, and specifying the line segment direction in accordance with the matching.

3. The method according to claim 1 wherein the step (b) includes selecting the picture having the overlapping domain containing a line segment in at least two different directions in the line segment of the pattern contained in the overlapping domain.

4. A composite picture forming apparatus providing a computation device that combines pictures by superimposing a plurality of pictures, stored in a picture memory, in a plurality of domains on a sample on an overlapping domain provided for the plurality of pictures, wherein
the computation device forms pattern attribute information contained in the overlapping domain, selects the pictures to be combined, by using the pattern attribute information, and performs a composition of the selected pictures.

5. The apparatus according to claim 4 wherein the computation device forms the pattern attribute information contained in the overlapping domain by using the design data of the sample.

6. The apparatus according to claim 5 wherein the computation device performs matching between the design data and pattern data present in the overlapping domain to form the pattern attribute information in accordance with the matching.

7. The apparatus according to claim 4 wherein the computation device determines a direction of a line segment of the pattern contained in the overlapping domain to select the picture having the overlapping domain indicating that direction information of the line segment satisfies a predetermined condition.

8. The apparatus according to claim 7 wherein the computation device selects the picture having the overlapping domain containing the line segment in at least two different directions in the line segment of the pattern contained in the overlapping domain.

9. A composite picture forming apparatus providing a computation device that combines pictures by superimposing a plurality of pictures, stored in a picture memory, in a plurality of domains on a sample on an overlapping domain provided for the plurality of pictures, wherein
the computation device combines the pictures indicating that pattern attribute information contained in the overlapping domain between the pictures arranged in a first direction satisfies a predetermined condition to form a plurality of picture groups, and combines the pictures indicating that the pattern attribute information contained in the overlapping domain between the pictures arranged in a second direction satisfies a predetermined condition to combine the picture groups for the plurality of picture groups.

10. The apparatus according to claim 9 wherein the computation device forms the pattern attribute information contained in the overlapping domain by using the design data of the sample.

11. The apparatus according to claim 10 wherein the computation device performs matching between the design data and pattern data present in the overlapping domain to form the pattern attribute information in accordance with the matching.

12. The apparatus according to claim 9 wherein the computation device determines a line segment direction of the pattern contained in the overlapping domain to select the picture having the overlapping domain indicating that direction information of the line segment satisfies a predetermined condition.

13. The apparatus according to claim 9 wherein the computation device selects the picture having the overlapping domain containing the line segment in at least two different directions in the line segment of the pattern contained in the overlapping domain.

14. A composite picture forming apparatus providing a computation device that combines pictures by superimposing a plurality of pictures, stored in a picture memory, on a plurality of domains on a sample on an overlapping domain provided for the plurality of pictures, wherein
the computation device selectively performs a composition of between the pictures, when pattern attribute information contained in the overlapping domain between the pictures satisfies a predetermined condition, to form either a plurality of composite pictures or one composite picture and perform the composition between either the plurality of composite pictures or the pictures not combined with the composite picture in accordance with the pattern attribute information of the plurality of overlapping domains between either the plurality of composite pictures or the pictures not combined with the composite picture.

15. The apparatus according to claim 14 wherein the computation device performs the composition between either the plurality of composite pictures or the pictures not combined with the composite picture, when the line segment in different direction is contained respectively in the plurality of overlapping domains.

16. The apparatus according to claim 14 wherein the computation device forms the pattern attribute information contained in the overlapping domain by using the design data of the sample.

17. The apparatus according to claim 16 wherein the computation device performs matching between the design data and pattern data present in the overlapping domain to form the pattern attribute information in accordance with the matching.

18. The apparatus according to claim 14 wherein the computation device determines the direction of the line segment of the pattern contained in the overlapping domain to select the picture having the overlapping domain indicating that direction information of the line segment satisfies a predetermined condition.
